(19) United States
(12) Patent Application Publication
(10) Pub. No.: US 2010/0052985 A1
(43) Pub. Date: Mar. 4, 2010

(54) ELECTRONIC DEVICE HAVING GNSS RECEIVER AND ACTIVATING AND POSITIONING METHOD THEREOF

(76) Inventors: Kuo-Wei Hung, Taipei (TW); Chao-Chih Wang, Taipei (TW); Ching-Feng Hsieh, Taipei (TW)

Correspondence Address: NORTH AMERICA INTELLECTUAL PROPERTY CORPORATION, P.O. BOX 506, MERRIFIELD, VA, 22116, US

(21) Appl. No.: 12/269,887

(22) Filed: Nov. 13, 2008

(30) Foreign Application Priority Data
Aug. 29, 2008 (TW) 097133197

(51) Int. Cl. G01S 5/14

(52) U.S. Cl. 342/357.13

(57) ABSTRACT

The prevent invention provides an activating and positioning method for an electronic device comprising at least a Global Navigation Satellite System (GNSS) receiver and a storage unit. The storage unit is utilized for storing a time file recording time information so that the time file can be obtained when activating the electronic device, and the time information recorded by the time file can be set as a current system time of the electronic device. Then, the activating and positioning method of the prevent invention activates the GNSS receiver to perform a positioning process according to the system time. Thus, the prevent invention can overcome disadvantages of the prior art which records system time by using hardware scheme.

### BACKGROUND OF THE INVENTION

1. Field of the Invention

The present invention relates to an electronic device having a Global Navigation Satellite System (GNSS) receiver and activating and positioning method thereof, and more particularly, to an electronic device not requiring hardware scheme for recording system time and activating and positioning method thereof.

2. Description of the Prior Art

The electronic device (such as a car navigation device) having a Global navigation satellite system (GNSS) receiver (such as Global Positioning System (GPS) receiver, Galileo receiver, and GLONASS receiver) are necessary in daily life for many users. However, this kind of electronic device has many problems to be solved, such as power consumption and hardware cost.

In general, the electronic device having the GNSS receiver has three activating modes: hard start mode, warm start mode, and cold start mode. The hard start mode requires the least time for positioning and time-calibrating process. The warm start mode requires more time for positioning and time-calibrating process. The cold start mode requires the most time for positioning and time-calibrating process. It is well know that the system time of the electronic device having the GNSS receiver is important for the positioning process of the GNSS receiver. If the system time of the electronic device becomes an initial value after the electronic device is turned off, it is required to use the cold start mode to activate the electronic device after the electronic device is turned off. In this way, more time will be spent for the positioning and time-calibrating process. The conventional solution is using hardware (such as a Real Time Clock (RTC) chip) to record the system time.

Please refer to FIG. 1. FIG. 1 shows a simplified block diagram of a conventional electronic device 100. As shown in FIG. 1, the electronic device 100 comprises a storage unit 110, a processing unit 120, a GNSS receiver 130, and an RTC chip 140. The GNSS receiver 130 is provided for receiving satellite information and performing a positioning process for the conventional electronic device 100. The RTC chip 140 is provided for recording system time. The processing unit 120 is provided for processing the satellite information, and obtaining the system time from the RTC chip 140 when activating the electronic device 100, and activating the GNSS receiver to perform a positioning process according to the system time. When the electronic device 100 is activated again after the electronic device 100 is turned off within a specific time (such as 4 hours), it is practical to use hard start mode to activate and position, and thus it can save much time during the positioning and time-calibrating process. When the electronic device 100 is activated again after the electronic device is turned off for over a specific time (such as 4 hours) and the electronic device 100 has obtained a current location, it is practical to use warm start mode to activate the electronic device 100, and thus it also can save some time during the positioning and time-calibrating process. However, since the conventional electronic device 100 uses the RTC chip 140 to record the system time, it needs more hardware cost, and the RTC chip 140 needs to be maintained in operation after the electronic device 100 is turned off, and it will consume much energy and shorten the battery using time of the electronic device 100.

### SUMMARY OF THE INVENTION

It is therefore one of the objectives of the present invention to provide an electronic device not requiring hardware scheme for recording system time and activating and positioning method thereof to solve the above problems.

To attain the above objective and the other objectives, the present invention discloses an activating and positioning method applied to an electronic device comprising at least a Global Navigation Satellite System (GNSS) receiver and a storage unit for storing a time file recording time information. The activating and positioning method comprises: activating the electronic device; obtaining the time file from the storage unit; setting the time information recorded by the time file as a current system time of the electronic device; and activating the GNSS receiver to perform a positioning process according to the system time.

The activating and positioning method can further comprises calibrating the system time according to satellite information received by the GNSS receiver after the GNSS receiver completes the positioning process. Additionally, the activating and positioning method can further comprises updating the time file according to the calibrated system time, to ensure real time of the time file. In an embodiment, the activating and positioning method updates the time file regularly (for example, by seconds or minutes) according to the calibrated system time. The time information recorded by the time file is generally a system time of the time file last updated before turning off the electronic device last time. However, when the electronic device is activated for the first time, the electronic device does not have the system time of the time file last updated before turning off the electronic device last time, and thus the time information recorded by the time file also can be a time default value embedded in the storage unit.

To attain the same objective, the present invention discloses an electronic device comprising a GNSS receiver, a storage unit, and a processing unit. The GNSS receiver is utilized for receiving satellite information and performing a positioning process. The storage unit is utilized for storing the satellite information and a time file recording time information. The processing unit is coupled to the GNSS receiver and the storage unit, and for processing the satellite information, obtaining the time file from the storage unit when activating the electronic device, setting the time information recorded by the time file as a current system time of the electronic device, and activating the GNSS receiver to perform a positioning process according to the system time.

In the above electronic device, the processing unit can further calibrates the system time according to satellite information received by the GNSS receiver after the GNSS receiver completes the positioning process. Additionally, the processing unit can further update the time file according to the calibrated system time, to ensure real time of the time file. In an embodiment, the processing unit updates the time file regularly according to the calibrated system time.

The electronic device having a GNSS receiver and activating and positioning method thereof disclosed by the present invention is realized by using the storage unit to store a time file, which can replace the conventional activating and positioning techniques using hardware (such as a Real Time Clock (RTC) chip) to record system time. Thus, the present invention can overcome the disadvantages of the conventional techniques using hardware to record system time, so as to save cost and energy.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a conventional electronic device.

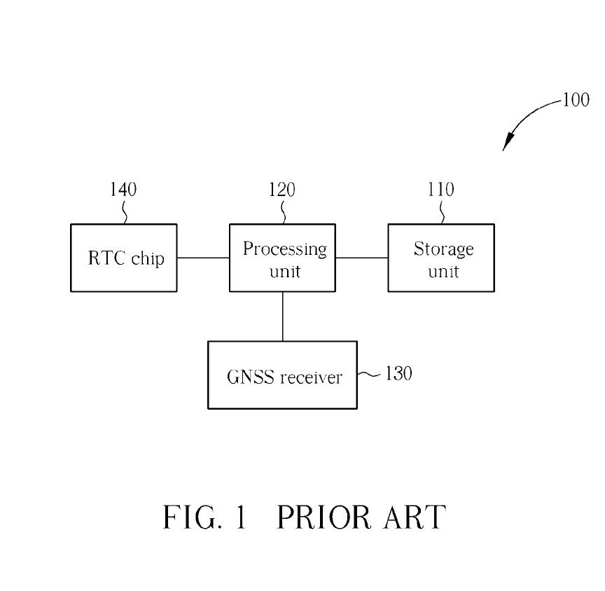

FIG. 2 shows a simplified block diagram of an electronic device according to an embodiment of the present invention.

FIG. 3 is a flowchart showing activating and positioning method applied to an electronic device according to a first embodiment of the present invention.

FIG. 4 is a flowchart showing activating and positioning method applied to an electronic device according to a second embodiment of the present invention.

FIG. 5 is a flowchart showing activating and positioning method applied to an electronic device according to a third embodiment of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

The present invention discloses an activating and positioning method applied to an electronic device comprising at least a Global Navigation Satellite System (GNSS) receiver and a storage unit for storing a time file recording time information. In an embodiment, the activating and positioning method comprises: activating the electronic device; obtaining the time file from the storage unit; setting the time information (such as 2008/08/01 1:00 pm) recorded by the time file as a current system time of the electronic device; and activating the GNSS receiver to perform a positioning process according to the system time. The activating and positioning method can further comprises calibrating the system time (for example, calibrating the system time to be 2008/08/01 3:00 pm) according to satellite information received by the GNSS receiver after the GNSS receiver completes the positioning process. Additionally, the activating and positioning method can further comprises updating the time file according to the calibrated system time, to ensure real time of the time file. In a preferred embodiment, the activating and positioning method updates the time file regularly (for example, by seconds or minutes) according to the calibrated system time. Before the time file is regularly updated according to the calibrated system time, the time information recorded by the time file is generally a system time of the time file last updated before turning off the electronic device last time. However, when the electronic device is activated for the first time, the electronic device does not have the system time of the time file last updated before turning off the electronic device last time, and thus the time information recorded by the time file also can be a time default value embedded in the storage unit.

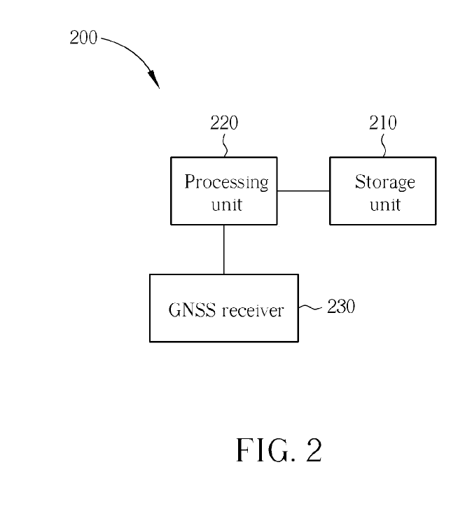

For example, please refer to FIG. 2. FIG. 2 shows a simplified block diagram of an electronic device 200 according to an embodiment of the present invention. As shown in FIG. 2, the electronic device 200 comprises a storage unit 210, a processing unit 220, and a GNSS receiver 230. The storage unit 210 is utilized for storing a time file recording time information, wherein the storage unit 210 can be a non-volatile memory such as a flash memory. The GNSS receiver 230 is utilized for receiving the satellite information and performing a positioning process, wherein the GNSS receiver 230 can be a Global Positioning System (GPS) receiver. The processing unit 220 is coupled to the GNSS receiver 230 and the storage unit 210, and for processing the satellite information, obtaining the time file from the storage unit when activating the electronic device, setting the time information recorded by the time file as a current system time of the electronic device, and activating the GNSS receiver 230 to perform the positioning process according to the system time.

In addition, the processing unit 220 can further calibrates the system time according to the satellite information received by the GNSS receiver 230 after the GNSS receiver 230 completes the positioning process. Meanwhile, the processing unit 220 can further update the time file according to the calibrated system time, to ensure real time of the time file. In a preferred embodiment, the processing unit 220 updates the time file regularly according to the calibrated system time. Please note that the above embodiment is only for an illustrative purpose and is not meant to be a limitation of the present invention.

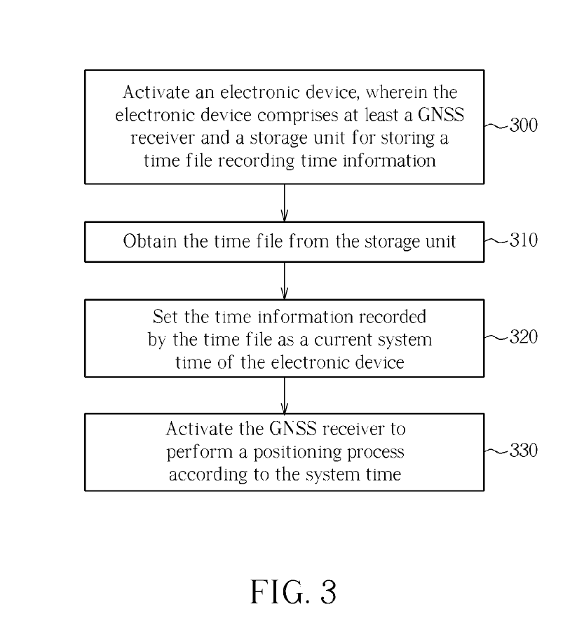

Please refer to FIG. 3. FIG. 3 is a flowchart showing activating and positioning method applied to an electronic device according to a first embodiment of the present invention. Provided that substantially the same result is achieved, the steps of the flowchart in FIG. 3 need not be in the exact order shown and need not be contiguous, that is, other steps can be intermediate. The activating and positioning method according to the first embodiment of the present invention comprises the following steps:

Step 300: Activate an electronic device, wherein the electronic device comprises at least a GNSS receiver and a storage unit for storing a time file recording time information;

Step 310: Obtain the time file from the storage unit;

Step 320: Set the time information recorded by the time file as a current system time of the electronic device;

Step 330: Activate the GNSS receiver to perform a positioning process according to the system time.

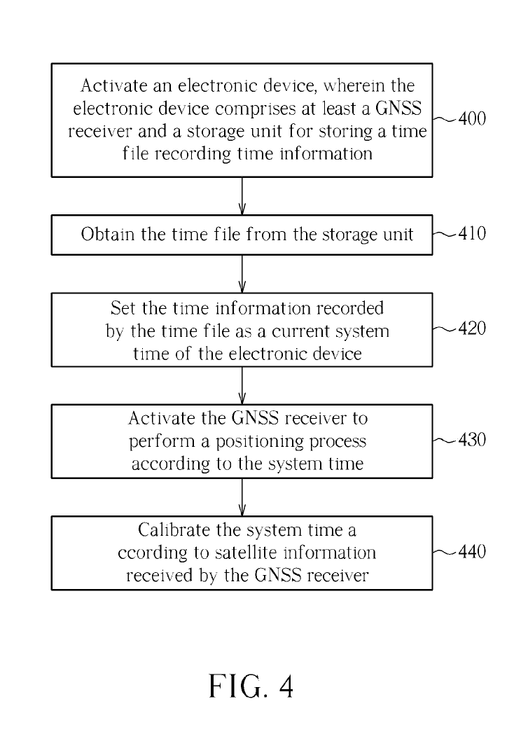

Please refer to FIG. 4. FIG. 4 is a flowchart showing activating and positioning method applied to an electronic device according to a second embodiment of the present invention. Provided that substantially the same result is achieved, the steps of the flowchart in FIG. 4 need not be in the exact order shown and need not be contiguous, that is, other steps can be intermediate. The activating and positioning method according to the second embodiment of the present invention comprises the following steps:

Step 400: Activate an electronic device, wherein the electronic device comprises at least a GNSS receiver and a storage unit for storing a time file recording time information;

Step 410: Obtain the time file from the storage unit;

Step 420: Set the time information recorded by the time file as a current system time of the electronic device;

Step 430: Activate the GNSS receiver to perform a positioning process according to the system time;

Step 440: Calibrate the system time according to satellite information received by the GNSS receiver.

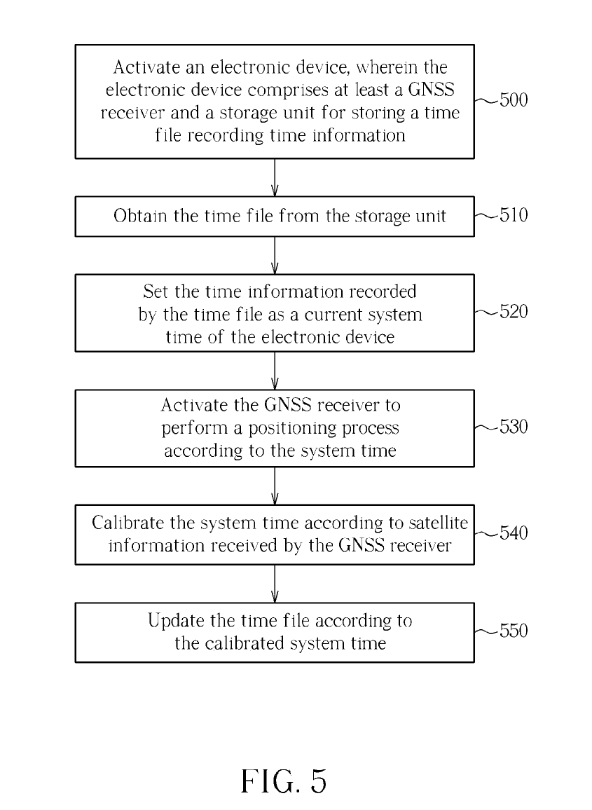

Please refer to FIG. 5. FIG. 5 is a flowchart showing activating and positioning method applied to an electronic device according to a third embodiment of the present invention. Provided that substantially the same result is achieved, the steps of the flowchart in FIG. 5 need not be in the exact order shown and need not be contiguous, that is, other steps can be intermediate. The activating and positioning method according to the third embodiment of the present invention comprises the following steps:

Step 500: Activate an electronic device, wherein the electronic device comprises at least a GNSS receiver and a storage unit for storing a time file recording time information;

Step 510: Obtain the time file from the storage unit;

Step 520: Set the time information recorded by the time file as a current system time of the electronic device;

Step 530: Activate the GNSS receiver to perform a positioning process according to the system time;

Step 540: Calibrate the system time according to satellite information received by the GNSS receiver;

Step 550: Update the time file according to the calibrated system time.

In the Step 550, the method of updating the time file is not limited. For example, it is practical to update when positioning each time, or regularly update when using the electronic device, i.e. update the time file regularly (for example, by seconds or minutes) according to the calibrated system time. There is no limitation for the updating period. The updating movement is preferred to be near the turn-off time of the electronic device.

Furthermore, although the above embodiments use the condition of storing the time file in advance for illustration, the condition of the electronic device having no time file when manufactured is also considered. Besides a time file recording a time default value in the storage unit of the electronic device, it is also practical to add a time file when the electronic device is activated for the first time. For example, it is practical to perform a determining step before the step of obtaining the time file in the above embodiments. The electronic device can determine whether the time file exist when activated each time. If the time file does not exist, the electronic device can add a time file recording a time default value. Since the step of adding a time file when the electronic device is activated for the first time does not affect the spirit of the invention, and a person of average skill in the pertinent art should be able to easily understand about adding the determining step, and thus further explanation of the details and operations are omitted herein for the sake of brevity.

Briefly summarized, the electronic device having a GNSS receiver and activating and positioning method thereof disclosed by the present invention is realized by using the storage unit to store a time file, which can replace the conventional activating and positioning techniques using hardware (such as a Real Time Clock (RTC) chip) to record system time. Thus, the present invention can overcome the disadvantages of the conventional techniques using hardware to record system time, so as to save cost and energy.

Those skilled in the art will readily observe that numerous modifications and alterations of the device and method may be made while retaining the teachings of the invention.

What is claimed is:

1. An activating and positioning method applied to an electronic device comprising at least a Global Navigation Satellite System (GNSS) receiver and a storage unit for storing a time file recording time information, the activating and positioning method comprising:
activating the electronic device;
obtaining the time file from the storage unit;
setting the time information recorded by the time file as a current system time of the electronic device; and
activating the GNSS receiver to perform a positioning process according to the system time.

2. The activating and positioning method of claim 1, further comprising:
calibrating the system time to generate a calibrated system time according to satellite information received by the GNSS receiver after the GNSS receiver completes the positioning process.

3. The activating and positioning method of claim 2, further comprising:
updating the time file according to the calibrated system time.

4. The activating and positioning method of claim 2, further comprising:
updating the time file regularly according to the calibrated system time.

5. The activating and positioning method of claim 4, wherein before the time file is regularly updated according to the calibrated system time, the time information recorded by the time file is a system time of the time file last updated before turning off the electronic device last time.

6. The activating and positioning method of claim 1, wherein the time information recorded by the time file is a time default value.

7. An electronic device, comprising:
a GNSS receiver, for receiving satellite information and performing a positioning process;
a storage unit, for storing the satellite information and a time file recording time information; and
a processing unit, coupled to the GNSS receiver and the storage unit, for processing the satellite information, obtaining the time file from the storage unit when activating the electronic device, setting the time information recorded by the time file as a current system time of the electronic device, and activating the GNSS receiver to perform a positioning process according to the system time.

8. The electronic device of claim 7, wherein the processing unit further calibrates the system time to generate a calibrated system time according to the satellite information received by the GNSS receiver.

9. The electronic device of claim 8, wherein the processing unit further updates the time file according to the calibrated system time.

10. The electronic device of claim 8, wherein the processing unit updates the time file regularly according to the calibrated system time.

11. The electronic device of claim 10, wherein before the time file is regularly updated according to the calibrated system time, the time information recorded by the time file is a system time of the time file last updated before turning off the electronic device last time.

12. The electronic device of claim 7, wherein the time information recorded by the time file is a time default value.

13. The electronic device of claim 7, wherein the storage unit is a non-volatile memory.

14. The electronic device of claim 13, wherein the non-volatile memory is a flash memory.

15. The electronic device of claim 7, wherein the processing unit is a processor.

16. The electronic device of claim 7, wherein the GNSS receiver is a Global Positioning System (GPS) receiver.
